(19) United States
(12) Patent Application Publication
(10) Pub. No.: US 2026/0042285 A1
(43) Pub. Date: Feb. 12, 2026

(54) METHODS AND DEVICES FOR MECHANICAL SEPARATION OF MULTILAYER TAPERED INTERLAYERS

(71) Applicant: SOLUTIA INC., ST. LOUIS, MO (US)

(72) Inventors: SUNGKYUN SOHN, LONGMEADOW, MA (US); JOSEPH EDWARD BIELIN, BELCHERTOWN, MA (US); NICHOLAS EDWARD KEEN, BRISTOL, TN (US)

(73) Assignee: SOLUTIA INC., ST. LOUIS, MO (US)

(21) Appl. No.: 19/102,162

(22) PCT Filed: Sep. 21, 2023
(86) PCT No.: PCT/US2023/074723

§ 371 Date: Feb. 7, 2025

Related U.S. Application Data
(60) Provisional application No. 63/377,413, filed on Sep. 28, 2022.
(60) Provisional application No. 63/448,707, filed on Feb. 28, 2023.

(51) Int. Cl. B32B 43/00; B29B 17/02; B29K 29/00; B29L 9/00

(52) U.S. Cl. CPC B32B 43/006; B29B 17/02; B29B 2017/0203; B29B 2017/0217; B29B 2017/0258; B29K 2029/00; B29L 2009/00; B32B 2309/02; B32B 2309/06; B32B 2329/06

(57) ABSTRACT

Processes are disclosed for separating a first layer from a remainder of a tapered multilayer interlayer sheet, in which the tapered multilayer interlayer sheet is heated, and thereafter the first layer is separated from the remainder of the tapered multilayer interlayer sheet by pulling the first layer and the remainder of the tapered multilayer interlayer sheet in different directions, in a defined orientation, without the tapered multilayer interlayer sheet wrinkling or tearing.

### BACKGROUND OF INVENTION

Multilayer interlayers have an ever-increasing share in the interlayer market but have limited recyclability in the extrusion process, since the different layers may have different physicochemical properties. When the multilayer interlayer materials (which include the skin and core layers) are added back into the skin layer extrusion process, the core layer materials, which are immiscible with the skin layer materials, form small but discrete domains of core layer material that cause a certain level of haze. Due to the formation of haze, the content of core layer material which can be added back into the skin layer must be limited. The inability to rework this multilayer material unlimitedly is a significant economic loss, as well as an environmental burden.

It is possible to manually peel off a skin layer from a multilayer sheet to demonstrate the concept of mechanical separation. However, improved processes and mechanical devices would be helpful for a stable, consistent, and cost-efficient mechanical separation operation.

U.S. Pat. No. 5,368,978 discloses a method of delaminating imaging materials comprising providing an imaging material comprising donor and receiver elements, heating said imaging material, applying opposed forces to said donor and receiver elements to separate said imaging material into donor and receiver elements, and accumulating the separated donor element. In a preferred method, one or both of said opposed forces is vacuum and when the vacuum is released from said donor element, accumulating takes place by spooling after separation. The apparatus for delamination of imaging materials comprises means for applying heat and pressure to said imaging material, means to apply a separating force to at least one of said donor element and receiver element forming said imaging material and means to separate said donor element and said receiver element. In a preferred embodiment the apparatus further comprises means to spool said donor element and means to preheat said imaging material prior to applying said separating force.

U.S. Pat. No. 5,934,577 discloses a process for separating the constituents of a multilayer material including at least one layer of a base plastic (A) and a layer of a plastic (B) which are separated by a layer of adhesive plastic (C), in which: (1) the material is heated to a temperature T1 between the crystallization temperature of the plastic B (Tc) and Tc−20° C., (2) the material is next shredded by being subjected to shearing, at approximately the same temperature, so as to produce delamination and thus to convert the material into particles of small dimensions of two types, some (X) consisting essentially of base plastic (A) and others (Y) consisting essentially of plastic B and of adhesive plastic (C), and (3) the particles X and Y are subsequently separated by electrostatic separation.

U.S. Pat. No. 10,513,102 discloses a peeling apparatus that includes: a conveyance roller configured to convey a laminate made by peelably laminating a first substrate and a second substrate including an opening; a peel roller arranged facing the conveyance roller with the laminate interposed in between, and configured to peel the second substrate from the first substrate; a winding roller arranged away from the peel roller, and configured to wind the second substrate peeled from the first substrate; and an auxiliary winding roller arranged between the peel roller and the winding roller, and including a stepped portion configured to maintain a width of the opening.

US 2020/0147933 A1 discloses a method for recycling an intermediate film for laminated glass, comprising a step of separating a layer comprising an A layer and a layer comprising a B layer from the intermediate film for laminated glass (1) comprising at least the A layer and the B layer.

WO2022/250944 discloses processes for separating a first layer from a remainder of a multilayer interlayer sheet, in which the multilayer sheet is heated, and thereafter the first layer is separated from the remainder of the multilayer interlayer sheet by pulling the first layer and the remainder of the multilayer interlayer sheet in different directions, in a defined orientation.

There remains a need for methods and devices for separating layers of multilayer interlayers, and particularly multilayer tapered (or wedge shaped) interlayers, to facilitate rework of the material in manufacturing processes.

The tapered (or wedge shaped) interlayers are often referred to as head-up display (“HUD”) interlayers or interlayers for HUD systems. These HUD interlayers are often used in laminated safety glass in vehicles equipped with HUD systems. HUD systems project an image of an instrument cluster or other important information to a location on the windshield in the direct line of sight of the vehicle operator. Such a display allows the driver to stay focused on the upcoming path of travel while visually accessing dashboard, navigation, and/or safety information.

To reduce ghost images in windshields, one way is to orient the inner and outer glass panels at an angle from one another. This aligns the position of the primary reflected image off the inner panel with the secondary image reflected off the outer panel to a single point, thereby creating a single image. Typically, this is done by displacing the outer panel relative to the inner panel by employing a wedge-shaped, or “tapered,” interlayer that includes at least one region of nonuniform thickness (i.e., a wedge shape instead of a constant or uniform thickness profile). With the advances to tapered interlayers, there is a need to have a method or process to facilitate separating the layers of the tapered interlayers for rework or recycling in manufacturing processes.

### SUMMARY OF INVENTION

In one aspect, the invention relates to continuous processes for separating a first layer from a remainder of a tapered multilayer interlayer sheet having a thicker side and a thinner side, the process comprising heating the tapered multilayer sheet to an elevated temperature; and thereafter separating the first layer from the remainder of the tapered multilayer interlayer sheet by pulling the first layer and the remainder of the tapered multilayer interlayer sheet in different directions. According to this aspect, a positioning roll, which is also a heating unit and is located before a separation point, is positioned so that it is tilted in the Z direction and/or the Y direction to prevent the thicker side of the tapered multilayer interlayer from shifting toward the middle of the roll, during the continuous process. The positioning roll may be tilted in the Z direction up to about 1% of the roll length, and up to about 0.5% of the roll length in the Y direction, between the panels that hold the roll, as further described below.

In another aspect, the invention relates to continuous processes for separating a first layer from a remainder of a tapered multilayer interlayer sheet, the process comprising: heating the tapered multilayer sheet to an elevated temperature; and thereafter separating the first layer from the remainder of the tapered multilayer interlayer sheet by pulling the first layer and the remainder of the tapered multilayer interlayer sheet in different directions in an orientation, while also tilting a positioning roll located between a separate heating unit and a separation point so that it is tilted in the Z direction and/or the Y direction to prevent the thicker side of the tapered multilayer interlayer from shifting toward the middle of the roll, during the continuous process. Thus, according to the invention, the positioning roll may also serve as the heating unit, or a heating unit may be provided that is separate from the positioning roll. According to the invention, an angle α is defined by the first layer and the tapered multilayer sheet at a separation point, an angle β is defined by the tapered multilayer sheet and the remainder of the tapered multilayer sheet at the separation point, and an angle γ is defined by the first layer and the remainder of the tapered multilayer sheet at the separation point, and the following formulas are satisfied:

$$β / α \geq 1$$

$$30 ° \leq γ \leq 180 °$$

$$α + β + γ = 360 ° .$$

According to the invention, the tilting of the positioning roll in the Z and/or Y direction and the orientation described is maintained during the continuous process. Tilting the positioning roll necessitates additional clarity on the aforementioned angles. The amount of tilting of the positioning roll may be changed depending on the wedge angle of the tapered multilayer interlayer. Since the amount of tilting of the positioning roll in the Z and/or Y direction is relatively small, the separation angles α and β change only slightly. As the positioning roll changes, the angle α at one end of the roll will be slightly different from the angle α at the other end of the roll, due to the movement of the roll in the Z and/or Y direction. The same is true for the angle β. Since the amount of tilting of the positioning roll in the Z and/or Y direction is relatively small, as described below, the angle will only change slightly. Along the positioning roll, the angles α and/or β will vary slightly from one end of the roll to the other, compared to when the positioning roll is not tilted (or is stationary at the origin. For use in the above equations, the angles α and β should be selected such that the angle β is at its smallest (at the point on the positioning roll where angle β is the smallest and defined by the first layer and the tapered multilayer sheet at a separation point) and the angle α is at its largest level and defined by the tapered multilayer sheet and the remainder of the tapered multilayer sheet at the separation point. The relative formulas above for α, β and γ will still be satisfied

In one aspect, a continuous process for separating a first layer from a remainder of a tapered multilayer interlayer sheet comprises:
a. heating the tapered multilayer interlayer sheet to a temperature from about 25° C. to about 70° C.; and
b. thereafter separating the first layer from the remainder of the tapered multilayer interlayer sheet by pulling the first layer and the remainder of the tapered multilayer interlayer sheet in different directions,
wherein an angle α defined by the first layer and the tapered multilayer interlayer sheet at the separation point is smaller than or equal to an angle β defined by the tapered multilayer interlayer sheet and the remainder of the tapered multilayer interlayer sheet at the separation point, during the continuous process, and
wherein the tapered multilayer interlayer sheet has a thicker side and a thinner side, and wherein a positioning roll located between a heating unit and the separation point is positioned so that it is tilted in the Z direction up to about 1% of the positioning roll length, or in the Y direction up to about 0.5% of the positioning roll length, or in both the Z direction up to about 1% of the positioning roll length and in the Y direction up to about 0.5% of the positioning roll length, to prevent the thicker side of the tapered multilayer interlayer sheet from shifting toward the middle of the positioning roll, during the continuous process.

In another aspect, a continuous process for separating a first layer from a remainder of a tapered poly(vinyl acetal) multilayer interlayer sheet comprises:
a. heating the tapered multilayer interlayer sheet to a temperature from about 25° C. to about 70° C.; and
b. thereafter separating the first layer from the remainder of the tapered multilayer interlayer sheet by pulling the first layer and the remainder of the tapered multilayer interlayer sheet in different directions,
wherein an angle α defined by the first layer and the tapered multilayer interlayer sheet at the separation point is smaller than or equal to an angle β defined by the tapered multilayer interlayer sheet and the remainder of the tapered multilayer interlayer sheet at the separation point, during the continuous process, and
wherein the tapered multilayer interlayer sheet has a thicker side and a thinner side, and wherein a positioning roll located between a heating unit and the separation point is positioned so that it is tilted in the Z direction up to about 1% of the positioning roll length, or in the Y direction up to about 0.5% of the positioning roll length, or in both the Z direction up to about 1% of the positioning roll length and in the Y direction up to about 0.5% of the positioning roll length, to prevent the thicker side of the tapered poly(vinyl acetal) multilayer interlayer sheet from shifting toward the middle of the positioning roll, during the continuous process.

In another aspect, a continuous process for separating a first layer from a remainder of a tapered multilayer interlayer sheet comprises:
a. heating the tapered multilayer interlayer sheet to a temperature from about 25° C. to about 70° C.; and
b. thereafter separating the first layer from the remainder of the tapered multilayer interlayer sheet by pulling the first layer and the remainder of the tapered multilayer interlayer sheet in different directions,
wherein an angle α defined by the first layer and the tapered multilayer interlayer sheet at the separation point is smaller than or equal to an angle β defined by the tapered multilayer interlayer sheet and the remainder of the tapered multilayer interlayer sheet at the separation point, during the continuous process, and
wherein the tapered multilayer interlayer sheet has a thicker side and a thinner side, and wherein a heating unit serving also as the positioning roll is positioned before the separation point so that it is tilted in the Z direction up to about 1% of the positioning roll length, or in the Y direction up to about 0.5% of the positioning roll length, or in both the Z direction up to about 1% of the positioning roll length and in the Y direction up to about 0.5% of the positioning roll length, to prevent the thicker side of the tapered multilayer interlayer sheet from shifting toward the middle of the positioning roll, during the continuous process.

In another aspect, a continuous process for separating a first layer from a remainder of a tapered poly(vinyl acetal) multilayer interlayer sheet comprises:
a. heating the tapered multilayer interlayer sheet to a temperature from about 25° C. to about 70° C.; and
b. thereafter separating the first layer from the remainder of the tapered multilayer interlayer sheet by pulling the first layer and the remainder of the tapered multilayer interlayer sheet in different directions,
wherein an angle α defined by the first layer and the tapered multilayer interlayer sheet at the separation point is smaller than or equal to an angle β defined by the tapered multilayer interlayer sheet and the remainder of the tapered multilayer interlayer sheet at the separation point, during the continuous process, and
wherein the tapered multilayer interlayer sheet has a thicker side and a thinner side, and wherein a heating unit (serving also as the positioning roll) positioned before the separation point is positioned so that it is tilted in the Z direction up to about 1% of the positioning roll length, or in the Y direction up to about 0.5% of the positioning roll length, or in both the Z direction up to about 1% of the positioning roll length and in the Y direction up to about 0.5% of the positioning roll length, to prevent the thicker side of the tapered poly(vinyl acetal) multilayer interlayer sheet from shifting toward the middle of the positioning roll, during the continuous process.

In another aspect, the invention relates to an interlayer containing the first layer obtained in the process described herein. In a further aspect, the invention relates to a composition containing the first layer obtained in the process described herein.

In another aspect, the invention relates to apparatuses for carrying out the methods of the invention.

Further aspects of the invention are as disclosed and claimed herein.

### BRIEF DESCRIPTION OF THE DRAWINGS

FIG. 1 is a schematic illustration of a method of mechanically recycling a multilayer interlayer.

FIG. 2 is a schematic illustration of a device according to the invention for mechanical separation of a multi-layer interlayer.

FIG. 3 is a schematic illustration of the proper orientation of the film while being separated.

FIG. 4 is a schematic illustration of mechanical separation of a tapered multilayer interlayer illustrating the tilting of the positioning roll in the Z and/or Y direction.

FIGS. 5(a) and 5(b) are diagrams showing the location of the positioning roll relative to the Cartesian axis.

FIGS. 6(a) to 6(h) are a series of diagrams showing the tilting of the positioning roll against the Cartesian coordinates.

FIGS. 7(a) to 7(d) are diagrams showing a view from the XZ plane on the tilting of the positioning roll toward the Z direction by angle θ.

FIGS. 8(a) to 8(d) are views from XY plane on the tilting of the positioning roll toward the Y direction by angle −ψ.

FIG. 9 is another schematic illustration of a device according to the invention for mechanical separation of a multi-layer interlayer.

FIG. 10 is another schematic illustration of a device according to the invention for mechanical separation of a multi-layer interlayer

FIG. 11 is a schematic illustration of the proper orientation of the film while being separated.

FIG. 12 is a schematic illustration of the proper orientation of the film while being separated.

FIG. 13 a schematic illustration of mechanical separation of a tapered multilayer interlayer illustrating the tilting of the positioning roll in the Z and/or Y direction.

### DETAILED DESCRIPTION

The following embodiments and combinations are included within the scope of the invention: a continuous process for separating a first layer from a remainder of a tapered multilayer interlayer sheet comprises:
a. heating the tapered multilayer interlayer sheet to a temperature from about 25° C. to about 70° C.; and
b. thereafter separating the first layer from the remainder of the tapered multilayer interlayer sheet by pulling the first layer and the remainder of the tapered multilayer interlayer sheet in different directions,
wherein an angle α defined by the first layer and the tapered multilayer interlayer sheet at the separation point is smaller than or equal to an angle β defined by the tapered multilayer interlayer sheet and the remainder of the tapered multilayer interlayer sheet at the separation point, during the continuous process, and
wherein the tapered multilayer interlayer sheet has a thicker side and a thinner side, and wherein a positioning roll located between a heating unit and the separation point is positioned so that it is tilted in the Z direction up to about 1% of the positioning roll length, or in the Y direction up to about 0.5% of the positioning roll length, or in both the Z direction up to about 1% of the positioning roll length and in the Y direction up to about 0.5% of the positioning roll length, to prevent the thicker side of the tapered multilayer interlayer sheet from shifting toward the middle of the positioning roll, during the continuous process. In some aspects, the tapered multilayer interlayer sheet is a poly(vinyl acetal) sheet.

In the process, in some aspects, the positioning roll is located between the heating unit and the separation point, and the positioning roll is positioned and tilted in the Z direction up to about 1% of the positioning roll length and in the Y direction up to about 0.5% of the positioning roll length. In other aspects, the heating unit may itself serve as the positioning roll, and no separate positioning roll is needed.

In some aspects, the first layer comprises a poly(vinyl butyral) polymer having a Tg from about 25° C. to about 40° C. In some aspects, the tapered multilayer interlayer sheet is heated in step a) to a temperature from 30° C. to 70° C. In some aspects, at least a portion of the remainder of the tapered multilayer interlayer sheet comprises a poly(vinyl butyral) polymer having a Tg that is at least 15° C. lower than the Tg of the first layer.

In some aspects of the process, in the separating step, the first layer is pulled by a first layer pull-roll and the remainder of the tapered multilayer interlayer sheet is pulled by a remainder pull roll, and wherein a distance between the first layer pull-roll and the remainder pull-roll is maintained, that is less than about 50% of the width of the sheet, while the separating occurs

In some aspects the process further comprises cooling one or more of the first layer and the remainder of the tapered multilayer interlayer sheet below a Tg of a poly(vinyl butyral) of the first layer or a Tg of a poly(vinyl butyral) of the remainder of the tapered multilayer interlayer sheet, and in some aspects, the process further comprises cooling the first layer to a temperature from about 15° C. to about 30° C., or the process further comprises cooling the remainder of the tapered multilayer interlayer sheet to a temperature from about −15° C. to about 0° C.

In some aspects, the distance between the first layer pull-roll and the remainder pull-roll is less than about 15% of the width of the sheet, while the separating occurs, or the distance between the first layer pull-roll and the remainder pull-roll is less than about 5% of the width of the sheet, while the separating occurs.

In some aspects, the tapered multilayer interlayer sheet comprises a core layer, with a skin layer on each side. In some aspects, the first layer comprises a first skin layer, and wherein the first skin layer is thicker than the other skin layer. Further, in some aspects, the first layer comprises a first skin layer, and wherein the first skin layer is thinner than the other skin layer.

In some aspects, the tilting is at least 0.001 mrad. In some aspects, the wedge angle variation of the interlayer to be separated is about +0.15 mrad.

In another aspect, a continuous process for separating a first layer from a remainder of a tapered multilayer interlayer sheet comprises:
a. heating the tapered multilayer interlayer sheet to a temperature from about 25° C. to about 70° C.; and
b. thereafter separating the first layer from the remainder of the tapered multilayer interlayer sheet by pulling the first layer and the remainder of the tapered multilayer interlayer sheet in different directions,
wherein an angle α defined by the first layer and the tapered multilayer interlayer sheet at the separation point is smaller than or equal to an angle β defined by the tapered multilayer interlayer sheet and the remainder of the tapered multilayer interlayer sheet at the separation point, during the continuous process, and
wherein the tapered multilayer interlayer sheet has a thicker side and a thinner side, and wherein a heating unit (serving also as the positioning roll) positioned before the separation point is positioned so that it is tilted in the Z direction up to about 1% of the positioning roll length, or in the Y direction up to about 0.5% of the positioning roll length, or in both the Z direction up to about 1% of the positioning roll length and in the Y direction up to about 0.5% of the positioning roll length, to prevent the thicker side of the tapered multilayer interlayer sheet from shifting toward the middle of the positioning roll, during the continuous process.

In another aspect, a continuous process for separating a first layer from a remainder of a tapered poly(vinyl acetal) multilayer interlayer sheet comprises:
a. heating the tapered multilayer interlayer sheet to a temperature from about 25° C. to about 70° C.; and
b. thereafter separating the first layer from the remainder of the tapered multilayer interlayer sheet by pulling the first layer and the remainder of the tapered multilayer interlayer sheet in different directions,
wherein an angle α defined by the first layer and the tapered multilayer interlayer sheet at the separation point is smaller than or equal to an angle β defined by the tapered multilayer interlayer sheet and the remainder of the tapered multilayer interlayer sheet at the separation point, during the continuous process, and
wherein the tapered multilayer interlayer sheet has a thicker side and a thinner side, and wherein a heating unit positioned before the separation point is positioned so that it is tilted in the Z direction up to about 1% of the positioning roll length, or in the Y direction up to about 0.5% of the positioning roll length, or in both the Z direction up to about 1% of the positioning roll length and in the Y direction up to about 0.5% of the positioning roll length, to prevent the thicker side of the tapered poly(vinyl acetal) multilayer interlayer sheet from shifting toward the middle of the positioning roll, during the continuous process.

The processes according to the invention are described herein as continuous, but the word “continuous” is not intended to be especially limited. One skilled in the art of industrial processes will understand that continuous processes may be distinguished from batch processes, and that the longer a process is able to be maintained continuously, the greater the advantage in terms of throughput. Thus, an advantage of the processes of the invention is that, in steady-state, a multilayer sheet roll may be continuously separated for a significant period of time and that, according to the present disclosure, one skilled in the art is enabled to adjust the processes to maintain a desired continuity in carrying them out. The invention and the claims are thus intended to encompass any process that may be artificially interrupted or disturbed in an attempt to avoid the process being carried out continuously. Other aspects are as disclosed and claimed herein.

Thus, in one aspect, the invention relates to methods and devices to separate two layers of a tapered multilayer interlayer by (i) unwinding the tapered interlayer from a roller; (ii) heating the tapered interlayer with one or more heated rollers and/or a separate IR heater (iii) peeling away the first, or skin, layer under a separation force; and (iv) collecting the separated skin layer and the remainder of the tapered multilayer sheet for subsequent re-use as an interlayer component. In this aspect, a positioning roll located between a heating unit and a separation point, or serving also as the heating unit, is positioned so that it is tilted in the Z direction and/or the Y direction to prevent the thicker side of the tapered multilayer interlayer from shifting toward the middle of the roll, during the continuous process. The positioning roll may be tilted in the Z direction up to about 1%, or up to about 0.9, 0.8, 0.7, 0.6, 0.5, 0.4, 0.3, 0.2, 0.1 or less of the roll length, and up to about 0.5% or up to about 0.4, 0.3, 0.2, 0.1 or less of the roll length in the Y direction, between the panels that hold the roll, as further described below.

In some aspects, the heating unit and/or positioning roll is tilted at least 0.01 milliradians and less than 0.05 milliradians in the Z direction.

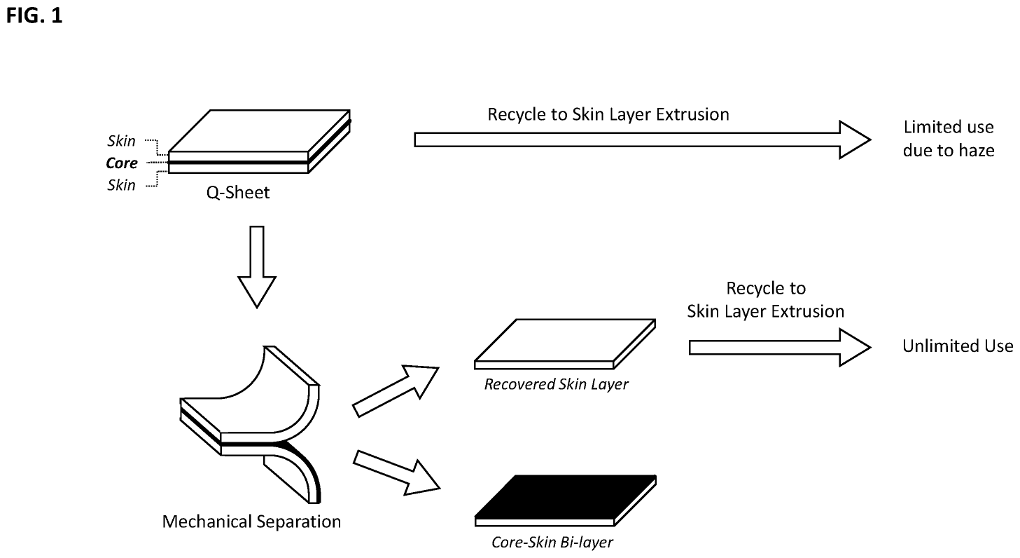

In another aspect, the invention relates to a method and the design of a device, in which the core and skin materials of tapered acoustic multilayer interlayer rework material (sometimes referred to as wedged or head-up display (“HUD”) interlayer or sheet), for example up to about 1.4 m in roll width and 500 kg in roll weight (although longer and heavier rolls may also be used), are separated by mechanically peeling off one skin layer of the tapered multilayer interlayer sheet at 2 to 20 m/min rate, for example, which allows unlimited usage of the recovered skin layer in extrusion. See FIG. 1 for a general overview of the process. As used herein, the tapered multilayer interlayer describes a tapered or wedge shaped interlayer having a core layer and two skin layers (i.e., a tri-layer interlayer), although tapered multilayer interlayers having more layers could also be used with appropriate modifications.

This invention thus relates to methods and devices that are capable of mechanically separating a first or skin layer from tapered (or wedge shaped) multilayer interlayer sheets (e.g. Eastman's Saflex™ acoustic HUD PVB interlayers). In this aspect, the goal is thus to mechanically separate one skin layer from a core-skin bi-layer of tapered acoustic (wedge shaped) tri-layer interlayers, but the scope of processible materials for the device disclosed in this invention is not limited to the tri-layers, but includes tapered multilayer interlayers, in which the number of layers is more than 2, or more than 3, or more than 5, or 5 or more, either in part or in whole in cross-machine direction of the sheet and where the interlayer is tapered or wedge shaped. The separation typically takes place between the skin layer adjacent to the acoustic core layer, and the rest of the sheet including the core layer itself.

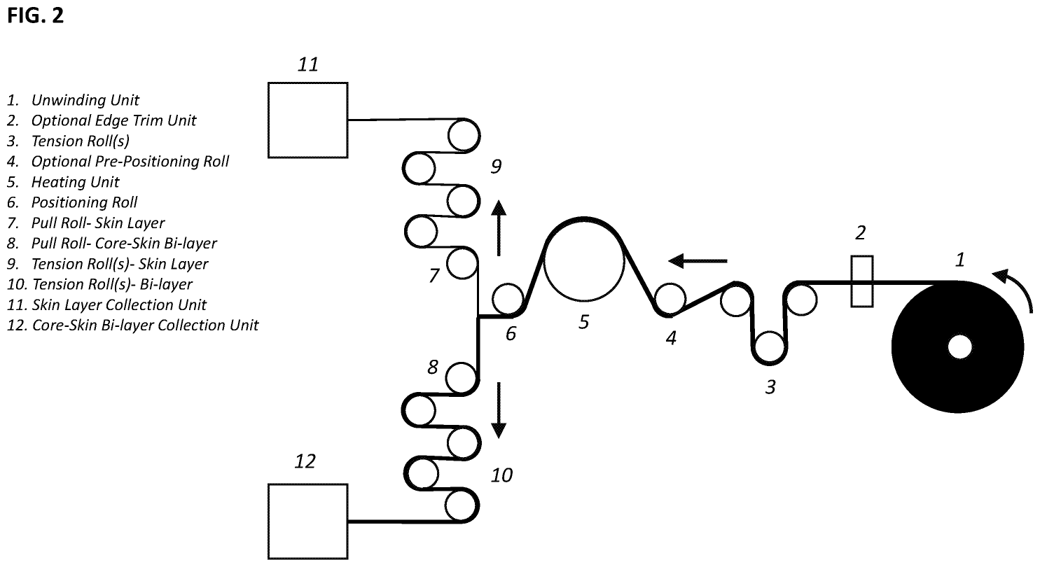

As illustrated in FIG. 2, in one embodiment, a mechanical separation device for unwinding tapered multilayer interlayers may be comprised of (1) an unwinding unit, (2) an optional edge trim unit, (3) one or more tension roll(s), (4) a pre-positioning roll with optional cooling, (5) a heating or annealing unit, (6) a further or second positioning roll with optional cooling, (7) a first layer pull-roll for the first or skin layer, (8) a remainder pull-roll for the remainder of the sheet, which is typically a core-skin bi-layer, (9) one or more tension roll(s) for the first or skin layer, (10) one or more tension roll(s) for the remainder of the sheet, typically the core-skin bi-layer, (11) a skin layer collection unit, which may be a winder, a container with or without a nip system, or a granulator (or other collection device), and (12) a core-skin bi-layer collection unit, which may be a winder, a container with or without a nip system, or a granulator (or other collection device).

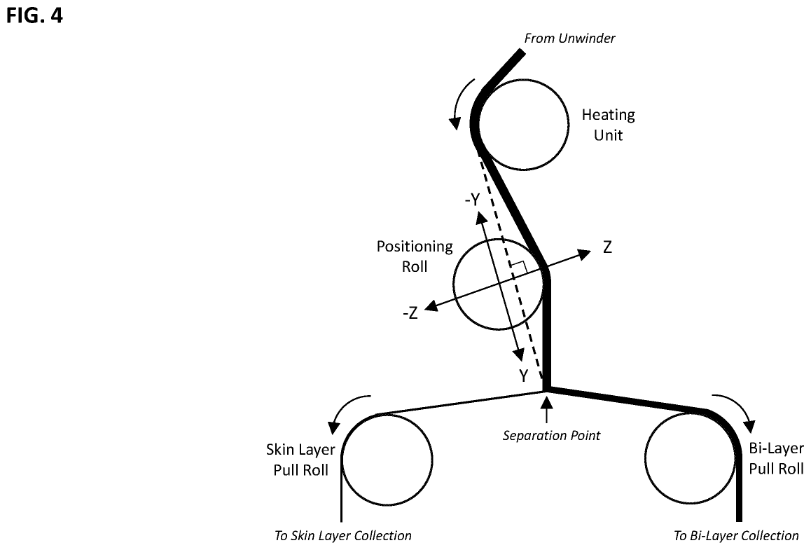

To unwind tapered interlayers, there is one pre-positioning roll (4) that is used to guide or position the tapered interlayer as it unwinds from the unwinding unit (1). As shown in FIG. 4, the second positioning roll (identified as roll (6) in FIG. 2) is located between the heating unit and the separation point, and this positioning roll may be precisely tilted either toward the Z direction, toward the Y direction, or both toward the Z direction and the Y direction, to prevent the thicker side of the tapered multilayer interlayer from moving or shifting its location toward the middle of the roll and causing the thinner side of the sheet to wrinkle, which will ultimately cause the process to stop and/or the sheet to tear.

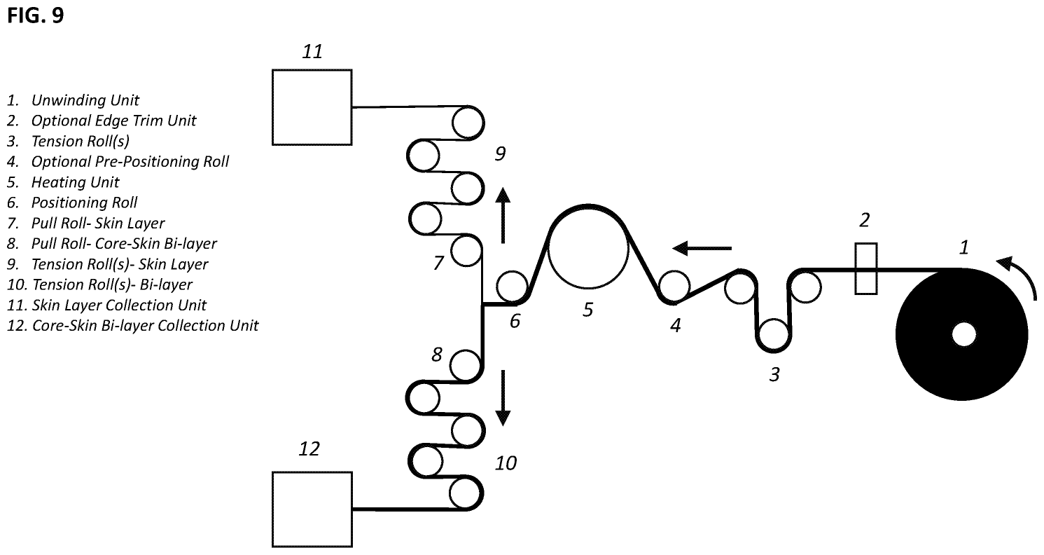

As illustrated in FIG. 9, in one embodiment, a mechanical separation device for unwinding tapered multilayer interlayers may be comprised of (1) an unwinding unit, (2) an optional edge trim unit, (3) one or more tension roll(s), (4) an optional pre-positioning roll with optional cooling, (5) a heating or annealing unit, (6) a positioning roll, (7) a first layer pull-roll for the first or skin layer, (8) a remainder pull-roll for the remainder of the sheet, which is typically a core-skin bi-layer, (9) one or more tension roll(s) for the first or skin layer, (10) one or more tension roll(s) for the remainder of the sheet, typically the core-skin bi-layer, (11) a skin layer collection unit, which may be a winder, a container with or without a nip system, or a granulator (or other collection device), and (12) a core-skin bi-layer collection unit, which may be a winder, a container with or without a nip system, or a granulator (or other collection device). The positioning roll (6) is positioned by tilting as already described herein to prevent creep.

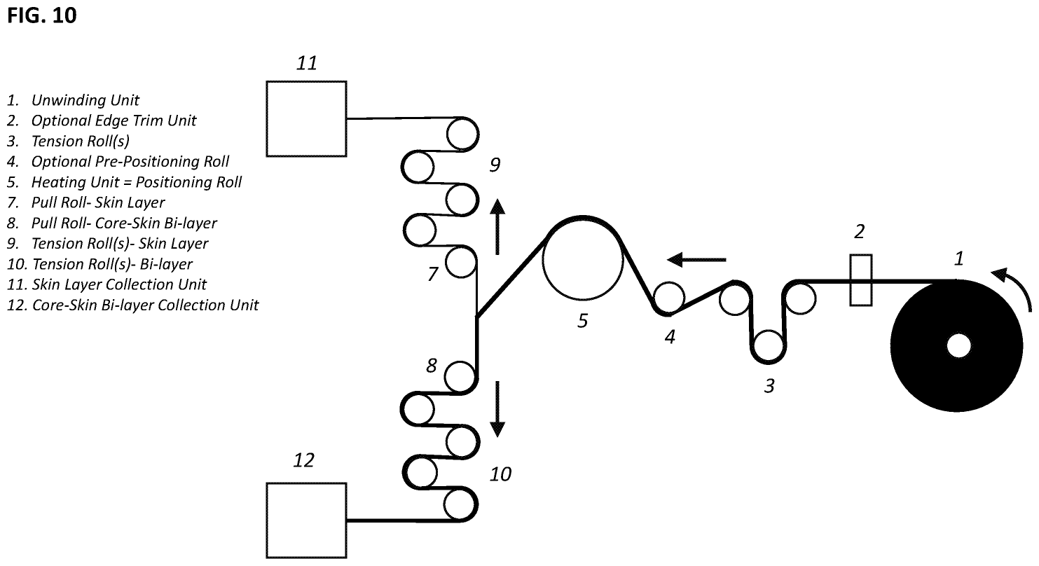

As illustrated in FIG. 10, in one embodiment, a mechanical separation device for unwinding tapered multilayer interlayers may be comprised of (1) an unwinding unit, (2) an optional edge trim unit, (3) one or more tension roll(s), (4) an optional pre-positioning roll with optional cooling, (5) a heating or annealing unit, which serves also as the positioning roll, (7) a first layer pull-roll for the first or skin layer, (8) a remainder pull-roll for the remainder of the sheet, which is typically a core-skin bi-layer, (9) one or more tension roll(s) for the first or skin layer, (10) one or more tension roll(s) for the remainder of the sheet, typically the core-skin bi-layer, (11) a skin layer collection unit, which may be a winder, a container with or without a nip system, or a granulator (or other collection device), and (12) a core-skin bi-layer collection unit, which may be a winder, a container with or without a nip system, or a granulator (or other collection device. As shown in FIG. 10, there is no optional second positioning roll, but instead, the sheet is fed from the heating or annealing unit (5) directly to the separation point where it is split and fed to the first layer pull-roll for the first or skin layer (7) and the remainder pull-roll for the remainder of the sheet (8). The heating unit, which is also the positioning roll, is tilted as described herein to prevent the sheet from creeping, that is, from moving or shifting its location toward the middle of the roll and causing the thinner side of the sheet to wrinkle.

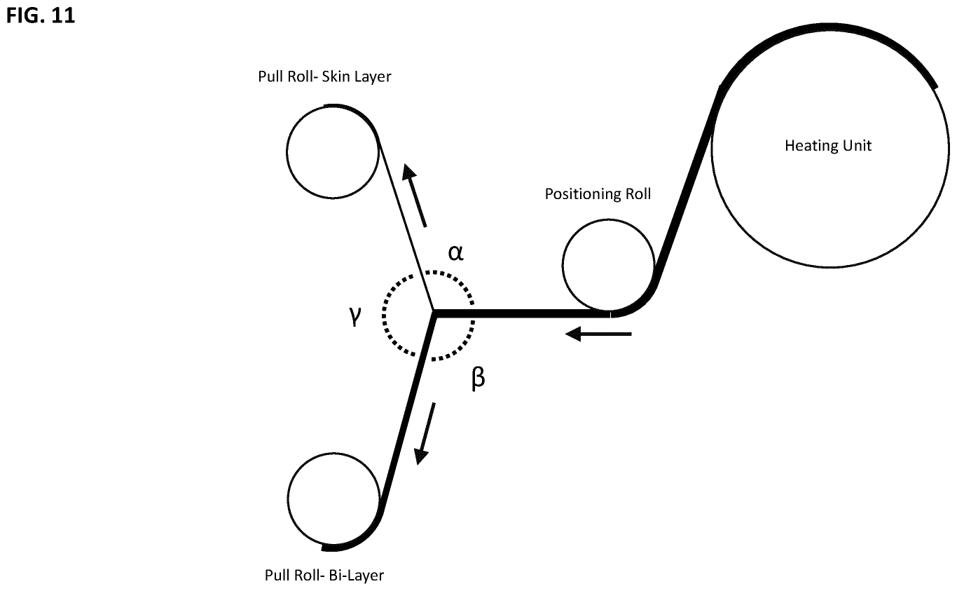

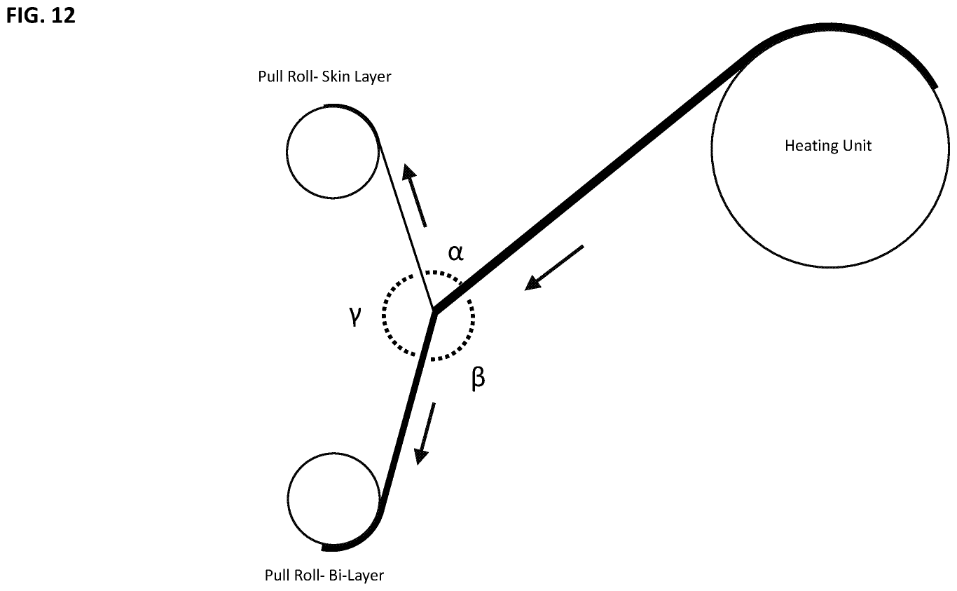

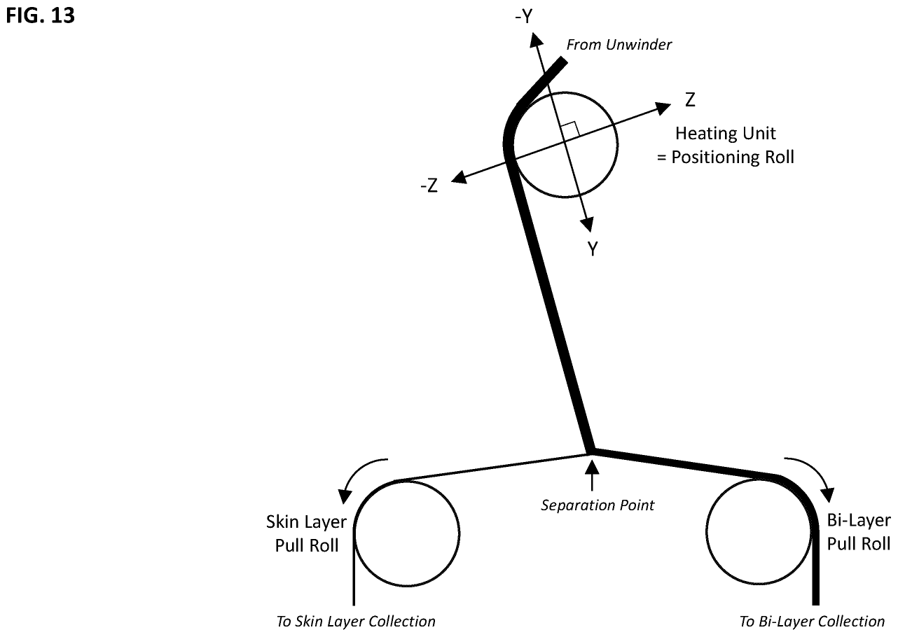

To unwind tapered interlayers, in another embodiment, there is one optional pre-positioning roll (4) that is used to guide or position the tapered interlayer as it unwinds from the unwinding unit (1). As shown in FIG. 11, the positioning roll (identified as roll (6) in FIGS. 2 and 9) is located between the heating unit (5) and the separation point, and this positioning roll may be precisely tilted either toward the Z direction, toward the Y direction, or both toward the Z direction and the Y direction, to prevent the thicker side of the tapered multilayer interlayer from moving or shifting its location toward the middle of the roll and causing the thinner side of the sheet to wrinkle, which will ultimately cause the process to stop and/or the sheet to tear. As shown in FIG. 12, there is no optional second positioning roll (6). Instead, the heating unit (5) serves also as the positioning roll and may thus be precisely tilted either toward the Z direction, toward the Y direction, or both toward the Z direction and the Y direction, to prevent the thicker side of the tapered multilayer interlayer from moving or shifting its location toward the middle of the roll and causing the thinner side of the sheet to wrinkle or become bunched, which will ultimately cause the process to stop and/or the sheet to tear.

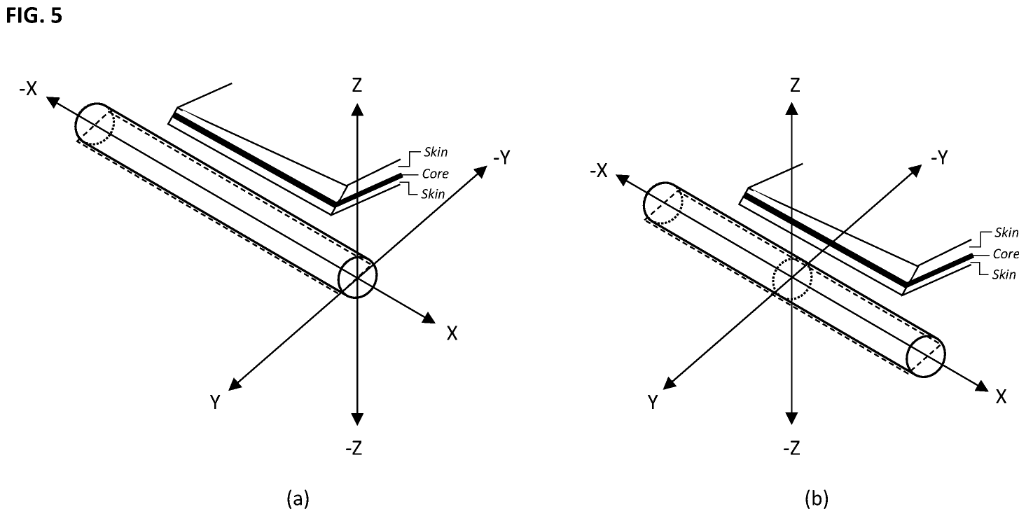

As the positioning roll or the heating unit (or roll) is tilted, the location of the roll end that corresponds to the thinner side of the sheet must be at least slightly above that of the positioning roll end that corresponds to the thicker side of the sheet in the Z direction of the Cartesian coordinates, as shown in FIG. 5. In addition, the location of the positioning roll or heating unit end that corresponds to the thinner side of the sheet should be equal to or below that of the roll end that corresponds to the thicker side of the sheet in the Y direction. Either one end or both ends of the positioning roll or heating unit can be tilted (in the Z and/or Y directions) to achieve the change and cause the sheet not to wrinkle as it is unwound, as demonstrated in FIG. 5 and further explained below.

FIGS. 5(a) and 5(b) are diagrams showing the location of the positioning roll that is tilted, relative to the Cartesian axis. In FIG. 5(a), the end of the roll that corresponds to the thicker side of the sheet is at the origin, while in FIG. 5(b) the mid-point of the roll width is at the origin. The rectangle with dotted lines inside the roll represents the positioning roll or heating unit, where the rectangle is drawn slightly outside the roll to clearly illustrate the dotted lines.

It is possible to have one or more additional positioning roll(s) or tension bar(s) (or similar device known in the art) that is placed between the positioning roll (described below) and the separation point. In this case, the positioning roll or tension bar (or other device used to help position the sheet and provide the needed tension) will be referred to as the ‘positioning roll’ when defining the invention and the amount of tilting, and the positioning roll described may be referred to as the heating unit when determining the amount of tilting necessary in the Z and/or Y direction to facilitate unwinding of the tapered interlayer, when the heating unit serves also as the positioning roll. As described above, and shown in the Figures, it is also possible to have fewer positioning rolls in some embodiments. Further, it is possible to have additional rolls, tension bars, or the like (not shown) as desired.

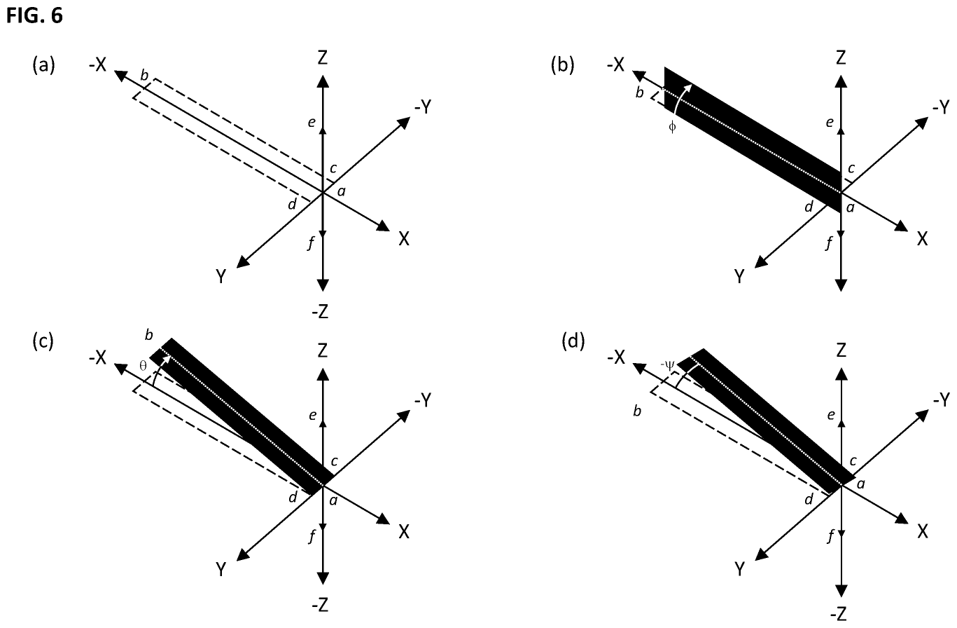

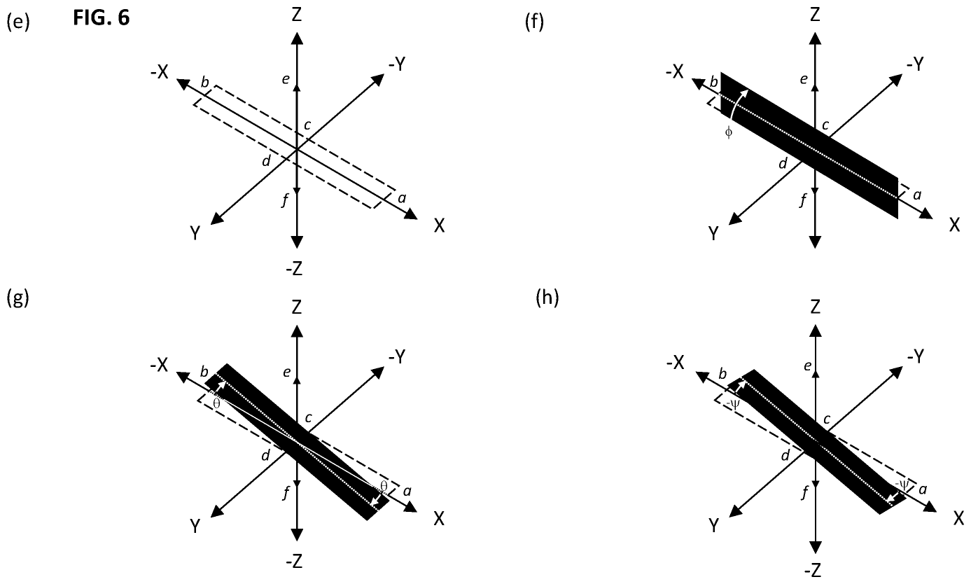

FIGS. 6(a) to 6(h) are a series of diagrams showing the tilting of the positioning roll against the Cartesian coordinates. For FIGS. 6(a) to 6(d), the end of the roll that corresponds to the thicker side of the sheet is at the origin, while for FIGS. 6(e) to 6(h), the mid-point of the roll width is at the origin. In FIGS. 6(a) and 6(e), coordinates X, Y, Z and the axes ab, cd, and ef are fixed to the roll. In FIGS. 6(b) and 6(f), the roll is tilted about the axis ab by angle ϕ, which has no effect on preventing wrinkling. In FIGS. 6(c) and 6(g), the roll is tilted about the axis cd by angle θ. In FIGS. 6(d) and 6(h), the roll is tilted about the axis ef by angle −ψ.

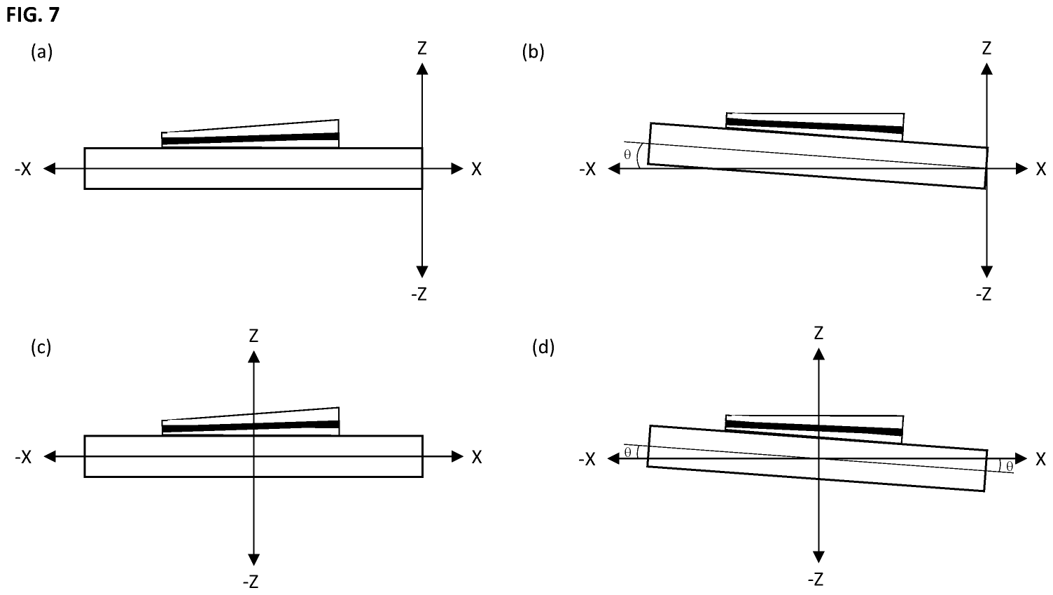

FIGS. 7(a) to 7(d) are diagrams showing a view from the XZ plane on the tilting of the positioning roll toward the Z direction by angle θ, where FIGS. 7(a) and 7(c) are before tilting and FIGS. 7(b) and 7(d) are after tilting of the roll. For FIGS. 7(a) and 7(b), the end of the roll that corresponds to the thicker side of the sheet is at the origin, while for FIGS. 7(c) and 7(d), the mid-point of the roll width is at the origin.

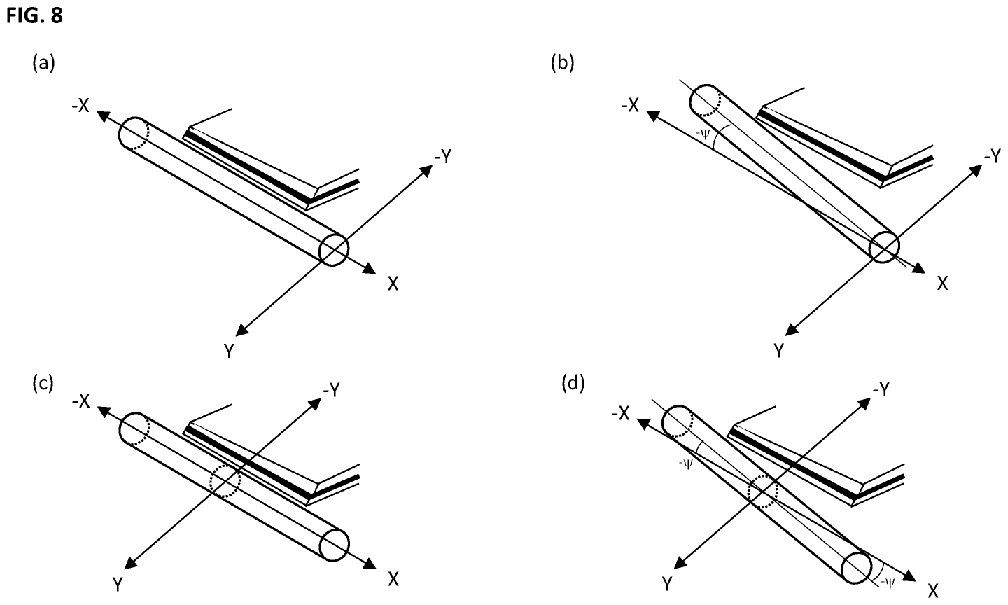

FIGS. 8(a) to 8(d) are views from the XY plane on the tilting of the positioning roll toward the Y direction by angle −ψ, where FIGS. 8(a) and 8(c) are before tilting and FIGS. 8(b) and 8(d) are after tilting. For FIGS. 8(a) and 8(b), the end of the roll that corresponds to the thicker side of the sheet is at the origin, while for FIGS. 8(c) and 8(d), the mid-point of the roll width is at the origin.

The unwinding unit (1) may be either motorized or non-motorized and is ideally capable of handling, for example, up to 1.4 m of roll width and 500 kg of roll weight (or larger), although other lengths and weights may be used.

The optional edge trim unit (2) can trim either side of the sheet or both sides of the sheet, if needed, along the machine-direction of the sheet before the sheet is transferred to the heating unit (5). Trimming may be done, for example, in order to keep the sheet width consistent, to separate and collect only the desired portion of the sheet, and/or to prevent tearing from the edges. Such cases would include, but would not be limited to, trimming a gradient portion of the sheet, or trimming an edge of the sheet where there is no core layer. In general, trimming at least about 25 mm from each edge by fixed blades may be helpful. This can be done either before the roll is placed on the unwinding unit (1), or at any point between the unwinding unit (1) and the heating unit (5).

The one or more tension roll(s) (3) are typically motorized so that the sheet can be pulled from the unwinding unit (1) and be fed to the heating or annealing unit (5). Unless the tension is properly set to flatten the sheet as it passes through the tension roll(s), the sheet may wrinkle in the cross-machine direction, causing uneven heating, leading to processing issues.

Referring for example to FIG. 2, a first positioning roll with optional cooling (4) follows the tension rolls (3) and is preferably located adjacent the heating unit (5) or the main thermal energy source of the annealing unit (5), to establish an adequate level of tension of the sheet before the sheet reaches the heating unit (5) by positioning the sheet on the correct path. For fine-tuning of the sheet temperature, this roll has optional cooling capacity. This roll is typically not motorized, but if desired it may be motorized.

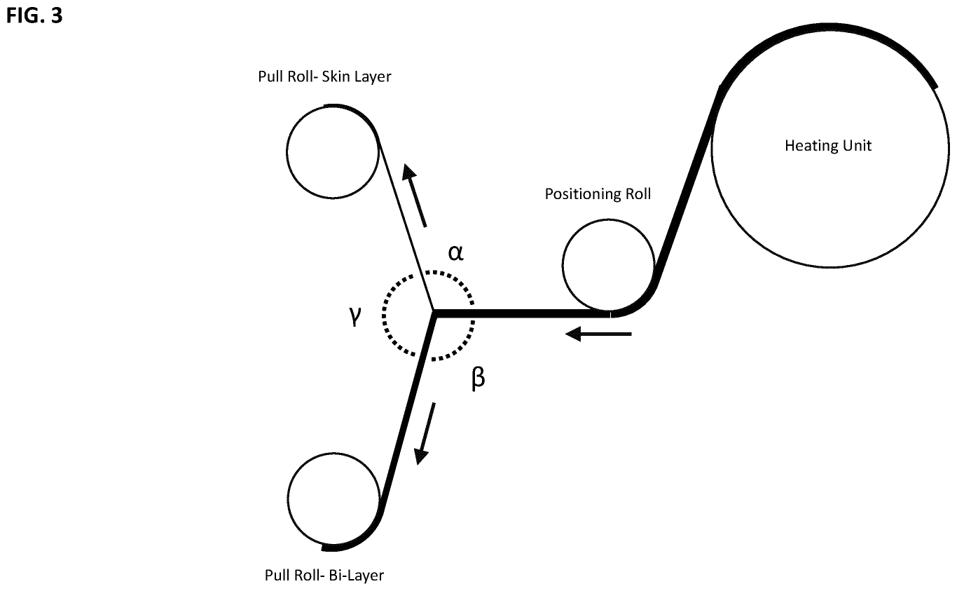

The heating unit (5) is in contact with either one of the skin layers or both skin layers, such that the interfacial binding energy between at least one of the skin layers and the core layer becomes low enough. This enables one of the skin layers to be mechanically separated from the rest of the sheet, upon application of a pulling force. The thermal energy source can be either singular or multiple heated roll(s), or infrared heater(s), or any combination of both (or other heat source known in the art), which may be placed on one side or both sides of the sheet. For commercial operation, it is important that the sheet interface, or orientation angles as described in FIG. 3, that is mechanically separated, is maintained and stays consistent throughout the duration of operation, that is, that the first layer be the layer that is removed from the rest of the sheet throughout the operation. If not, the layer recovered at the first layer collection unit may also contain part of the remainder of the sheet, for example the core layer. And for that reason, it may be preferred that the thermal energy to the sheet is supplied mainly through conduction by a heated roll.

The temperature range of the sheet surface closest to the thermal energy source achieved by the annealing unit, typically the first or skin layer, may be from about ambient or room temperature to about 70° C., or from about 25° C. to about 70° C., or from 30° C. to 65° C., or from 35° C. to 60° C., or at least about 25° C., at least about 30° C., at least about 35° C. or more, or less than about 70° C., less than about 65° C., or less than 60° C., or as described elsewhere herein. This may be measured by IR thermometer at the exit of the heating unit. If the temperature of the sheet surface is too low, mechanical separation of the sheet may not occur, and consequently the sheet may tear. If the temperature of the sheet surface is too high, the mechanical integrity of the sheet may drop, making it difficult to handle or process, and stable operation of the mechanical separation process may be difficult. The annealing or heating unit (3) is preferably a motorized roller.

In other aspects, the temperature of the sheet surface closest to the thermal energy source achieved by the annealing unit, typically the first or skin layer, is at least about 25° C., or at least about 26° C., or at least 27° C., or at least 28° C., or at least 30° C., or at least 32° C., or at least 35° C., and up to about 70° C., or up to about 65° C., or up to about 60° C., or up to about 55° C., or up to about 50° C.

The tilted positioning roll (6) with optional cooling (when present) is located on the opposite side of the heating unit (5) or the main thermal energy source of the annealing unit, to establish an adequate level of tension of the sheet before the sheet reaches the point of separation, by positioning the sheet on the correct path. For fine-tuning of the sheet temperature, this roll may have optional cooling capacity. The positioning roll (6) with optional cooling can be a spreader roll that is designed to eliminate wrinkles of the sheet by surface action in the cross-machine direction, so that the sheet becomes wrinkle free and ready to be cleanly separated when the sheet reaches the point of separation. This roll is typically not motorized.

Tapered multilayer interlayers provide a greater challenge when unwinding and separating the first or skin layer from the core-skin bi-layer. The pulling force in the mechanical separation process is not only consumed in interfacial separation, but also in stretching the skin and the bi-layer. Because the sheet is tapered, there is an imbalance (or difference) in sheet thickness in the cross-machine direction. The thicker side of the sheet inevitably takes more force than the thinner side as it is being separated. As the sheet is unwound and pulled, the thicker side of the sheet gradually makes its way toward the middle of the second positioning roll, causing the thinner side to wrinkle, which causes process disruptions. The separation line or process changes from a linear one to a higher order curve over time (as the point of separation does not remain linear but instead, has a curve, such as a parabolic curve, or a smile or frown shape), and finally, it becomes impossible to continue unwinding and separating the layers without tearing the sheet.

To overcome this problem and to keep the tapered multilayer interlayer from moving and wrinkling, the inventors have discovered that by precisely tilting one of the rolls, such as the positioning roll located between the heating unit and the separation point (i.e., the positioning roll (6)) or the heating unit (5) in the Z direction, in the Y direction, or in both the Z direction and the Y direction, prevents the thicker side of the tapered multilayer interlayer from shifting its location toward the middle of the second positioning roll (6) and causing the thinner side of the sheet to wrinkle. The roll that is tilted should be the roll closest to (or just prior to) the separation point, depending on the configuration. As the positioning roll (6) or the heating unit (5) is tilted, it is critical that the location of the roll end that corresponds to the thinner side of the sheet is above that of the roll end that corresponds to the thicker side of the sheet, in the Z direction of the Cartesian coordinates defined in FIG. 5. In addition, the location of the roll end that corresponds to the thinner side of the sheet should be equal to or below that of the roll end that corresponds to the thicker side of the sheet, in the Y direction. Either one end or both ends of the positioning roll (6) or heating unit (5) may be tilted to achieve the change, as demonstrated in FIG. 5.

The effect of the precise positioning roll (6) tilting may be sufficient to enable one end of the roll tilting, as shown in FIG. 5(a). However, if the machine is modified such that both ends of the positioning roll (6) can be tilted (as in FIG. 5(b)), it enables even finer adjustments to be made on the apparatus and in the process to control the separation of the sheet and prevent wrinkling.

The tilting of the positioning roll or heating unit (or other roll) against the Cartesian coordinate is further explained by FIGS. 6(a) to 6(h). For FIGS. 6(a) to 6(d), the end of the roll that corresponds to the thicker side of the sheet is at the origin, while for FIGS. 6(e) to 6(h) the mid-point of the roll width is at the origin. In FIGS. 6(a) and 6(e), coordinate XYZ and the axis ab-cd-ef are fixed to the roll. When the roll is tilted about the axis ab by angle ϕ, as in FIGS. 6(b) and 6(f), there is no effect, and the roll just turns at its original location. In FIGS. 6(c) and 6(g), the roll is tilted about the axis cd by angle θ. In FIG. 6(c), the roll end that corresponds to the thinner side of the sheet is tilted toward the Z direction, while in FIG. 6(g), the roll end that corresponds to the thinner side of the sheet is tilted toward the Z direction, and the one that corresponds to the thicker side of sheet is tilted toward the −Z direction. The difference or delta in Z directional positions between the two roll ends, as a result of such tilting in FIGS. 6(c) and 6(g) is the same. In FIGS. 6(d) and 6(h), the roll is tilted about the axis ef by angle −ψ. In FIG. 6(d), the roll end that corresponds to the thinner side of the sheet is tilted toward the −Y direction, while in FIG. 6(h), the roll end that corresponds to the thinner side of the sheet is tilted toward the −Y direction, and the one that corresponds to the thicker side of sheet is tilted toward the Y direction. The delta in Y directional positions between the two roll ends, as a result of such tilting in FIGS. 6(d) and 6(h), is the same.

FIGS. 7 and 8 provide a view from the XZ plane on Z directional tilting, and a view from the XY plane on Y directional tilting, respectively. As illustrated in FIG. 7, because the sheet is under tension as it passes through the positioning roll (6), tilting the roll toward the Z direction will move the thicker side of the sheet in the Z axis, making it difficult for the sheet to shift its location toward the middle of the roll (or, stated differently, keeping the sheet in position so that it does not wrinkle). In FIG. 8, tilting the positioning roll (6) or heating unit (5) toward the Y direction (specifically the −Y direction) will fix the thicker side of the sheet in the Y axis under pulling tension, making it difficult for the sheet to shift its location toward the middle of the roll.

The positioning roll (6) can be either motorized or un-motorized. It can have a fully cylindrical shape across the width direction of the roll, or it can have journal sections either at one end or at both ends of the roll. In either case, the surface of the positioning roll that faces or touches the sheet can be smooth or it can have some surface roughness and/or pattern, and it can be a material such as stainless steel, carbon steel, Teflon, natural or synthetic rubber. Further, the positioning roll (6) may be flat or slightly tapered to spread the sheet as it leaves the roll. Optionally, it can be either heated or cooled.

To allow the positioning roll to tilt, the location of the positioning roll end(s) can be made adjustable. For example, cutting movable ranges for all bolts on the panel that holds the bearing portion of the roll will allow the position of the roll to be adjusted. For example, metal plates on both sides of the panel can hold the bolts, and the whole parts including the metal plates and the bolts holding the roll can be tilted as needed within the cut ranges. Maximum tilting in the Z direction for a positioning roll is about 1% of the roll length between the two panels (or sides) that hold the roll in place. Tilting of about 1% of the roll length corresponds to 10 milliradians in angle θ. For some rolls or processes, desirable tilting in the Z direction is 0.8% or less (8 milliradians or less in angle θ). In certain aspects, the positioning roll may be tilted 0.9%, 0.8%, 0.7%, 0.6%, 0.5%, 0.4%, 0.3%, 0.2%, 0.1% or less. Maximum tilting in the Y direction for a positioning roll is 0.5% of the roll length between the two panels that hold the roll, which corresponds to 5 milliradians in angle −Y. For some rolls, desirable tilting in the Y direction is 0.4%, 0.3%, 0.2%, 0.1% or less (4 milliradians or less in angle −Y). In certain aspects, the positioning roll may be tilted 0.3%, 0.2%, 0.1% or less. These lengths or angles include displacements or angles from both ends of the positioning roll (6).

To allow the heating unit or roll to tilt (for example, when there is no positioning roll or other roll just prior to the separation point), the location of the heating unit end(s) can be made adjustable. For example, cutting movable ranges for all bolts on the panel that holds the bearing portion of the roll will allow the position of the roll to be adjusted. For example, metal plates on both sides of the panel can hold the bolts, and the whole parts including the metal plates and the bolts holding the roll can be tilted as needed within the cut ranges. Maximum tilting in the Z direction for a heating unit is about 1% of the roll length between the two panels (or sides) that hold the roll in place. Tilting of about 1% of the roll length corresponds to 10 milliradians in angle θ. For some rolls or processes, desirable tilting in the Z direction is 0.8% or less (8 milliradians or less in angle θ). In certain aspects, the heating unit may be tilted 0.9%, 0.8%, 0.7%, 0.6%, 0.5%, 0.4%, 0.3%, 0.2%, 0.1% or less. Maximum tilting in the Y direction for a heating unit is 0.5% of the roll length between the two panels that hold the roll, which corresponds to 5 milliradians in angle −Y. For some rolls, desirable tilting in the Y direction is 0.4%, 0.3%, 0.2%, 0.1% or less (4 milliradians or less in angle −Y). In certain aspects, the heating unit may be tilted 0.3%, 0.2%, 0.1% or less. These lengths or angles include displacements or angles from both ends of the heating unit.

The tilting necessary may be very slight, such as at least 0.01 mrad or more, depending on various factors such as the wedge angle of the sheet, the roll width, the number of positioning rolls (if present). In embodiments, the tilting of a roll, such as the positioning roll or the heating unit, may be very slight and only about 0.01 mrad or more.

As the tapered multilayer sheet moves through the process, the tapered multilayer sheet then becomes mechanically separated between the first layer pull-roll for the first or skin-layer (7) and the remainder pull-roll for the remainder or core-skin bi-layer (8). The first layer pull-roll for the skin-layer (7), is downstream from the positioning roll for separation, (6), and it takes the mechanically separated skin layer from the rest of the sheet. The remainder pull-roll for the core-skin bi-layer (8) is also downstream of the positioning roll for separation, (6), and the heating or annealing unit (5), and it takes the remainder, or core-skin bi-layer. When there is no second positioning roll (6), or alternatively, an additional roll after the second positioning roll (6), the remainder pull-roll for the core-skin bi-layer (8) is downstream of the heating or annealing unit (5) and/or any additional roll (not shown), and it takes the remainder, or core-skin bi-layer.

For commercial operation, it is important that the sheet interface or orientation angles, as described in FIG. 3, that is mechanically separated, is maintained and stays relatively consistent throughout the duration of operation, that is, that the first layer be the layer that is removed from the rest of the sheet throughout the continuous operation. If not, the layer recovered at the first layer collection unit may also contain part of the remainder of the sheet, for example the core layer.

As illustrated in FIGS. 3, 11 and 12, according to the invention, the angle α is the angle defined by the first layer and the tapered multilayer sheet at the separation point, after the sheet departs the second positioning roll. The angle β is the angle defined by the tapered multilayer sheet and the remainder of the multilayer sheet at the separation point, after the sheet departs the second positioning roll. Also as depicted in FIGS. 3, 11 and 12, an angle γ is depicted that is defined by the first layer and the remainder of the tapered multilayer sheet, after the separation point. As depicted, the sum of the three angles, α+β+γ, is 360°.

According to the invention, it is important that the angle α is equal to or smaller than the angle β, especially the latter, and such condition is maintained throughout the duration of the continuous sheet separation operation. Typically, the separation machine is designed such that the angle γ is equal to or smaller than 180°, and equal to or larger than 30° throughout the duration of the continuous sheet separation operation.

Thus, according to the invention, the angle α may be, for example, from about 30 to about 150°, or from about 35 to about 160°, or from about 40° to about 165°. Further, the angle β may be, for example, from about 90° to about 180°, or from about 95° to from about 150°, or from 100° to 120°. Likewise, the angle γ may be from about 30° to about 180°, or from 45 to 150°, or from 50 to 120°.

In other aspects, the angles according to the invention may be as follows, with the delta being the difference β minus a:

$$γ = 180 ° ; α = 60 ° ; β = 120 ° \qquad Δ60°$$

$$γ = 150 ° ; α = 90 ° ; β = 120 ° \qquad Δ30°$$

$$γ = 120 ° ; α = 90 ° ; β = 150 ° \qquad Δ60°$$

$$\begin{matrix}γ = 100 ° ; α = 80 ° ; β = 180 ° & Δ100°\end{matrix} .$$

In one aspect, to minimize sheet wrinkling after the mechanical separation, the distance between the first pull-roll for the skin-layer (7) and the remainder pull-roll for the core-skin bi-layer (8), defined as the distance between the centers of the two rolls (7) and (8), may be, for example, less than 50% of the width of the sheet that is being processed. We define this number as ψ. It may be more desirable if ψ is less than 30%, or less than 20%, or less than 15% of the width of the sheet that is being processed.

In addition, the first pull-roll for the skin layer (7) and the remainder pull-roll (8) can be spreader rolls to prevent wrinkles from forming on the mechanically separated layers. The term “spreader rolls,” as used herein, mean rolls designed to eliminate wrinkles by surface action in the cross-machine direction.

The tension roll(s) for the skin layer (9) are preferably motorized in sync with the first pull-roll for skin-layer (7), just as the tension roll(s) for the core-skin bi-layer (10) are preferably motorized in sync with the remainder pull-roll for the core-skin bi-layer (8), in order to assist in driving the whole mechanical separation process, and to stably transfer the separated first or skin layer and the remainder or core-skin bi-layer to the skin layer collection unit (11) and the core-skin bi-layer collection unit (12), respectively.

The skin layer collection unit (11) can be either a motorized winder, or a granulator, or a container, or any other collection device. This is where the recovered skin layer is collected for re-use, such as in an extrusion process. Alternatively, the skin layer can be merely collected in a container or the like for further processing, with or without a nip system that feeds the sheet stably into the container.

The core-skin bi-layer collection unit (12) also can be either a motorized winder, or a pelletizer, or a container, or any other collection device. The collected core-skin bi-layer may be re-used in extrusion, or further mechanically processed or transferred for use in chemical recycling. Similarly, the core-skin bi-layer can be merely collected in a container or the like for further processing, with or without a nip system that feeds the sheet stably into the container.

The range of total sheet thickness processible on the device disclosed in this invention is typically from about 0.254 mm to about 5.080 mm, or from 0.508 to 2.540 mm, or from 0.762 to 1.270 mm, although other sheet thicknesses may be possible.

The operational speed at which such mechanical separation takes place on the device disclosed in this invention may be, for example, from about 2 to about 20 m/min, or from 5 to 10 m/min, based on the sheet unwinding speed. Both pull rolls run 1.1 to 2.5 times faster than the unwinding speed. In other words, 2.2 to 50 m/min, or 5.5 to 25 m/min, is the operational speed at the separation point.

Start-up of the mechanical separation device may be carried out as follows: [a] From the center of the tip of the tri-layer interlayer sheet, cut the sheet diagonally toward both directions, one at a time, making the tip of the sheet an arrow shape, [b] Manually peel off one skin layer from the tri-layer interlayer sheet on the tip of the arrow shape, then continue the separation of the sheet for about 25 cm, [c] Manually press the separated first skin layer and the core-skin bi-layer firmly onto the pull-roll for skin layer (7) and the pull-roll for core-skin bi-layer (8), respectively, and initiate thread up by very slowly jogging the machine, for example, slower than 1.0 m/min, [d] Thread up the skin layer through the pull-roll for skin layer (7) and to the tension roll(s) for the skin layer (9), [e] Thread up the core-skin bi-layer through the pull-roll for core-skin bi-layer (8) and to the tension rolls(s) for the core-skin bi-layer (10), [f] Jog all the motorized rolls to make sure a stable process is established, and [g] Increase the speed to the target and reach steady-state.

It will be understood that, once at steady state, the tapered multilayer interlayer sheet travels through the device as follows. The sheet is unwound from the unwinding unit (1) and the optional edge trim unit (2), then passes through the tension rolls (3) at ambient temperature before reaching the first positioning roll (4). The (optional) first positioning roll with optional cooling (4) may be chilled to a temperature, for example, of approximately ambient, or at the temperature coming from a water tap, or from about 10° C. to about 30° C., or from 15° C. to 30° C., or from 20° C. to 25° C., so as to bring the surfaces of the sheet to a temperature, for example, from about 15° C. to about 30° C., or from 20° C. to 25° C.

The sheet then is contacted with the heating unit (5), preferably a heated roll that heats the sheet surface closest to the thermal energy source to a temperature from about 35° C. to about 80° C., or from 43° C. to 75° C., or from 45° C. to 65° C., or as described elsewhere herein.

In embodiments, after the sheet is heated by the heating unit (5), the sheet is then conveyed to the second positioning roll (6) with optional cooling, located on the opposite side of the heating unit (5) or the main thermal energy source of the heating unit (5), from the first positioning roll. The second positioning roll (6) may be chilled to a temperature, for example as described above, to cause the surface of the sheet to have a temperature from about 5° C. to about 40° C., or from 10° C. to 30° C., or from 12° C. to 35° C. Alternatively, the surface of the sheet that is in contact with the second positioning roll (6) may be cooled to a temperature of at least 5° C., or at least 10° C., or at least 12° C., or at least 15° C., up to about 40° C., or up to 35° C., or up to 30° C. In other embodiments, there is no optional second positioning roll (6) and the sheet is conveyed from the heating unit (5) directly to the separation point. In this case, the heating unit serves also as the positioning roll, and is tilted accordingly.

After the sheet passes across the second positioning roll (6) or the heating unit (5) if there is no second positioning roll (6), the tapered multilayer sheet is mechanically separated by the first layer being pulled by the first pull-roll for skin layer (7) and the remainder of the sheet being pulled by the remainder pull-roll (8), with the orientation as already described. This mechanical separation, as noted, is begun during start-up, after which the methods and devices of the present invention ensure that the two layers continue to be cleanly separated during continuous operation.

As noted, in order to minimize sheet wrinkling after the mechanical separation, in one aspect the distance between the first layer pull-roll for the skin-layer (7) and the remainder pull-roll for the core-skin bi-layer (8), defined as the distance between the centers of the two rolls (7) and (8), is less than about 30% that of the width of the sheet that is being processed. It may be more desirable if the distance between the centers of the two rolls (7) and (8) is less than 25%, or less than 20%, or less than 15%.

As noted, in a significant aspect, the tapered multilayer interlayer sheet comprises a tapered multilayer PVB interlayer, for example a tapered or wedge shaped tri-layer having a skin/core/skin cross-section. Although a particular PVB interlayer has been described, a variety of interlayer materials may be used.

When the interlayers comprise polyvinyl butyral (PVB), the PVB resin may be produced by known acetalization processes by reacting polyvinyl alcohol (“PVOH”) with butyraldehyde in the presence of an acid catalyst, separation, stabilization, and drying of the resin. Such acetalization processes are disclosed, for example, in U.S. Pat. Nos. 2,282,057 and 2,282,026 and Wade, B. 2016, Vinyl Acetal Polymers, Encyclopedia of Polymer Science and Technology. 1-22 (online, copyright 2016 John Wiley & Sons, Inc.), the entire disclosures of which are incorporated herein by reference. The resin is commercially available in various forms, for example, as Butvar® Resin from Solutia Inc., a wholly owned subsidiary of Eastman Chemical Company.

As used herein, residual hydroxyl content (calculated as % vinyl alcohol or % PVOH by weight) in PVB refers to the amount of hydroxyl groups remaining on the polymer chains after processing is complete. For example, PVB can be manufactured by hydrolyzing poly(vinyl acetate) to poly(vinyl alcohol (PVOH), and then reacting the PVOH with butyraldehyde. In the process of hydrolyzing the poly(vinyl acetate), typically not all of the acetate side groups are converted to hydroxyl groups. Further, reaction with butyraldehyde typically will not result in all hydroxyl groups being converted to acetal groups. Consequently, in any finished PVB resin, there typically will be residual acetate groups (as vinyl acetate groups) and residual hydroxyl groups (as vinyl hydroxyl groups) as side groups on the polymer chain. As used herein, residual hydroxyl content and residual acetate content is measured on a weight percent (wt. %) basis per ASTM D1396.

The PVB resins of the present disclosure typically have a molecular weight of greater than 50,000 Daltons, or less than 500,000 Daltons, or about 50,000 to about 500,000 Daltons, or about 70,000 to about 500,000 Daltons, or about 100,000 to about 425,000 Daltons, as measured by size exclusion chromatography using low angle laser light scattering. As used herein, the term “molecular weight” means the weight average molecular weight.

Various adhesion control agents (“ACAs”) can be used in the interlayers of the present disclosure to control the adhesion of the interlayer sheet to glass. In various embodiments of interlayers of the present disclosure, the interlayer can comprise about 0.003 to about 0.15 parts ACAs per 100 parts resin; about 0.01 to about 0.10 parts ACAs per 100 parts resin; and about 0.01 to about 0.04 parts ACAs per 100 parts resin. Such ACAs, include, but are not limited to, the ACAs disclosed in U.S. Pat. No. 5,728,472 (the entire disclosure of which is incorporated herein by reference), residual sodium acetate, potassium acetate, magnesium bis(2-ethyl butyrate), and/or magnesium bis(2-ethylhexanoate).

Other additives may be incorporated into the interlayer to enhance its performance in a final product and impart certain additional properties to the interlayer. Such additives include, but are not limited to, dyes, pigments, stabilizers (e.g., ultraviolet stabilizers), antioxidants, anti-blocking agents, flame retardants, IR absorbers or blockers (e.g., indium tin oxide, antimony tin oxide, lanthanum hexaboride (LaB₆) and cesium tungsten oxide), processing aides, flow enhancing additives, lubricants, impact modifiers, nucleating agents, thermal stabilizers, UV absorbers, dispersants, surfactants, chelating agents, coupling agents, adhesives, primers, reinforcement additives, and fillers, among other additives known to those of ordinary skill in the art.

Although the embodiments described refer to the polymer resin as being PVB, it would be understood by one of ordinary skill in the art that the polymer may be any polymer suitable for use in a multiple layer panel. Typical polymers include, but are not limited to, polyvinyl acetals (PVA) (such as poly(vinyl butyral) (PVB) or isomeric poly(vinyl isobutyral) (PVisoB), polyurethane (PU), poly(ethylene-co-vinyl acetate) (EVA), polyvinylchloride (PVC), poly(vinylchloride-co-methacrylate), polyethylenes, polyolefins, ethylene acrylate ester copolymers, poly(ethylene-co-butyl acrylate), silicone elastomers, epoxy resins, and acid copolymers such as ethylene/carboxylic acid copolymers and its ionomers, derived from any of the foregoing possible thermoplastic resins, combinations of the foregoing, and the like. PVB and its isomeric polymer PVisoB, polyvinyl chloride, and polyurethane are particularly useful polymers generally for interlayers; PVB (and its isomeric polymer) is particularly preferred.

In a further aspect, the diffusive interlayer can be a multilayered interlayer. For example, the multilayered interlayer can consist of PVB/PVisoB/PVB. Other examples include PVB/PVC/PVB or PVB/PU/PVB. Further examples include PVC/PVB/PVC or PU/PVB/PU. Alternatively, the skin and core layers may all be PVB using the same or different starting PVB resins.

In one aspect, the first or skin layer of the multilayer interlayer sheet comprises a PVB polymer having a Tg, for example, from about 20° C. to about 45° C., or from 25° C. to 40° C., or from 28° C. to 35° C. Alternatively, the Tg of the poly(vinyl butyral) may be at least about 20° C. or at least 25° C., or at least 28° C., up to about 45° C., or up to 40° C., or up to 35° C.

In an aspect, the Tg of the layer adjacent the first layer may be at least 12° C. lower, or at least 15° C. lower, or at least 20° C. lower, or at least 30° C. lower than the Tg of the first or skin layer.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10.

Notwithstanding that the numerical ranges and parameters setting forth the broad scope of the invention are approximations, the numerical values set forth in the specific examples are intended to be reported precisely in view of methods of measurement. Any numerical value, however, inherently contains certain errors necessarily resulting from the standard deviation found in their respective testing measurements.

It is to be understood that the mention of one or more process steps does not preclude the presence of additional process steps before or after the combined recited steps or intervening process steps between those steps expressly identified. Moreover, the denomination of process steps, ingredients, or other aspects of the information disclosed or claimed in the application with letters, numbers, or the like is a convenient means for identifying discrete activities or ingredients and the recited lettering can be arranged in any sequence, unless otherwise indicated.

As used herein, the singular forms “a”, “an”, and “the” include plural referents unless the context clearly dictates otherwise. For example, reference to a Cn alcohol equivalent is intended to include multiple types of Cn alcohol equivalents. Thus, even use of language such as “at least one” or “at least some” in one location is not intended to imply that other uses of “a”, “an”, and “the” excludes plural referents unless the context clearly dictates otherwise. Similarly, use of the language such as “at least some” in one location is not intended to imply that the absence of such language in other places implies that “all” is intended, unless the context clearly dictates otherwise.

As used herein the term “and/or”, when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

This invention can be further illustrated by the following examples of embodiments thereof, although it will be understood that these examples are included merely for purposes of illustration and are not intended to limit the scope of the invention unless otherwise specifically indicated.

### EXAMPLES

### Example 1

In a mechanical separation device, such as shown in the Figures, where tapered (wedge-shaped) multilayer PVB interlayer is processed, one end of the positioning roll located between the heating unit and the separation point was modified such that the roll end could tilt toward the Z direction, which is orthogonal to a hypothetical line that is defined by connecting the point where the multilayer interlayer departs the heating unit, and the separation point (as shown in FIGS. 4 to 8). The panel to panel (or side to side) distance (that is, the distance of the rolls plus any journal or other sections used to secure the roll in place) that holds the positioning roll was 1,778 mm when not tilted.

The end of the positioning roll was tilted toward the Z direction by 7.112 mm, or 4 milliradians. The wedge angle of the multilayer PVB interlayer being separated was 0.41 milliradian. The sheet width was 1.0 m. The interlayer was fed to the mechanical separation device, and to the positioning roll such that the thinner side of the sheet passed through the tilted side of the positioning roll. The interlayer was fed at 10 m/min and mechanically separated at 20 m/min, without process instability (i.e., the first skin layer was successfully separated from the core-skin bi-layer).

### Example 2

In a mechanical separation device, where tapered multilayer PVB interlayer is processed, both ends of the positioning roll located between the heating unit and the separation point were modified such that the roll ends could tilt toward the Z direction, as previously described. The panel to panel distance that holds the positioning roll was 1,778 mm when not tilted.

One end of the positioning roll was tilted toward the Z direction by 3.556 mm, or 4 milliradians. The other end of the positioning roll was also tilted toward the Z direction by 3.556 mm, or 4 milliradians. The wedge angle of the multilayer PVB interlayer being separated was 0.41 milliradian. The sheet width was 1.0 m. The interlayer was fed to the mechanical separation device, and to the positioning roll such that the thinner side of the sheet passed through the tilted side of the positioning roll. The interlayer was fed at 10 m/min and mechanically separated at 20 m/min, without process instability (i.e., the first skin layer was successfully separated from the core-skin bi-layer).

### Example 3

In a mechanical separation device, where wedge-shaped multilayer PVB interlayer is processed, one end of the positioning roll located between the heating unit and the separation point was modified such that the roll end could tilt toward the Z direction, as previously described. The same end of the positioning roll was also modified such that the roll end could tilt toward the Y direction, which is defined by a hypothetical line that connects the point where the multilayer interlayer departs the heating unit, and the separation point. The panel to panel distance that holds the positioning roll was 1,778 mm when not tilted.

The end of the positioning roll was tilted toward the Z direction by 7.112 mm, or 4 milliradians. It was tilted toward the Y direction by −0.003 mm, or −5 milliradians. The wedge angle of the multilayer PVB interlayer being separated was 0.41 milliradian. The sheet width was 1.0 m. The interlayer was fed to the mechanical separation device, and to the positioning roll such that the thinner side of the sheet passed through the tilted side of the positioning roll. The interlayer was fed at 5 m/min and mechanically separated at 10 m/min, without process instability (i.e., the first skin layer was successfully separated from the core-skin bi-layer)

### Example 4

In a mechanical separation device, where wedge-shaped multilayer PVB interlayer is processed, there is no second positioning roll after the heating unit. One end of the heating unit was slightly tilted toward the Z direction as previously described. The panel to panel distance that holds the heating unit was about 1,778 mm when not tilted.

The end of the positioning roll was tilted toward the Z direction by more than about 0.01 milliradians and less than about 0.05 milliradians. The wedge angle of the multilayer PVB interlayer being separated was about 0.15 milliradian. The sheet width was 1.0 m. The interlayer was fed to the mechanical separation device, and to the heating unit such that the thinner side of the sheet passed through the tilted side of the heating unit. The interlayer was fed at 5 m/min and mechanically separated at 10 m/min, without process instability (i.e., the first skin layer was successfully separated from the core-skin bi-layer).

### Comparative Example 1

In an unmodified mechanical separation device where the positioning roll was not tilted in either the Z direction and/or the Y direction, a wedge-shaped multilayer PVB interlayer was processed. The panel to panel distance that holds the positioning roll was 1,778 mm.

The wedge angle of the multilayer PVB interlayer was 0.41 milliradian. The sheet width was 1.0 m. Upon starting-up the mechanical separation process, the separation line across the width direction of the interlayer turned to a higher order curve (that is, a non-linear separation point, such as parabolic, frown shape or other curve that is not a relatively straight line). It was impossible to continue operation even at a very low speed of 2 m/min feeding and 5 m/min pulling.

Table 1 below shows the details of Examples 1 to 4 and Comparative Example 1 and whether or not stable separation was achieved.

TABLE 1

| | | 1^{st} Skin | | | | |
|---|---|---|---|---|---|---|
| | Unwind | Pull-roll | Z-direction | Z-direction | | Stable |
| | Speed | Speed | Tilt 1^{st} End | Tilt 2^{nd} End | Y-direction | Separation |
| | (m/min) | (m/min) | (mrad) | (mrad) | Tilt (mrad) | Process |
| Example 1 | 10 | 20 | 4 | 0 | 0 | Yes |
| Example 2 | 10 | 20 | 4 | 4 | 0 | Yes |
| Example 3 | 10 | 20 | 4 | 0 | −5 | Yes |
| Example 4 | 10 | 20 | <0.05 | 0 | 0 | Yes |
| Comp. | 2 | 5 | 0 | 0 | 0 | No |
| Example 1 | | | | | | |

1. A continuous process for separating a first layer from a remainder of a tapered multilayer interlayer sheet, the process comprising:
a. heating the tapered multilayer interlayer sheet to a temperature from about 25° C. to about 70° C.; and
b. thereafter separating the first layer from the remainder of the tapered multilayer interlayer sheet by pulling the first layer and the remainder of the tapered multilayer interlayer sheet in different directions,
wherein an angle α defined by the first layer and the tapered multilayer interlayer sheet at the separation point is smaller than or equal to an angle β defined by the tapered multilayer interlayer sheet and the remainder of the tapered multilayer interlayer sheet at the separation point, during the continuous process, and
wherein the tapered multilayer interlayer sheet has a thicker side and a thinner side, and wherein a positioning roll positioned before the separation point is positioned so that it is tilted in the Z direction up to about 1% of the positioning roll length, or in the Y direction up to about 0.5% of the positioning roll length, or in both the Z direction up to about 1% of the positioning roll length and in the Y direction up to about 0.5% of the positioning roll length, to prevent the thicker side of the tapered multilayer interlayer sheet from shifting toward the middle of the positioning roll, during the continuous process.

2. The continuous process of claim 1, wherein the positioning roll heats the tapered multilayer interlayer sheet in step a).

3. The continuous process of claim 1, wherein the multilayer interlayer sheet is heated in step a) by a heating unit.

4. The process of claim 1, wherein the positioning roll is positioned so that it is tilted in the Z direction up to about 1% of the positioning roll length and in the Y direction up to about 0.5% of the positioning roll length.

5. The process of claim 1, wherein the first layer comprises a poly(vinyl butyral) polymer having a Tg from about 25° C. to about 40° C.

6. The process of claim 1, wherein the tapered multilayer interlayer sheet is heated in step a) to a temperature from 30° C. to 70° C.

7. The process of claim 1, wherein at least a portion of the remainder of the tapered multilayer interlayer sheet comprises a poly(vinyl butyral) polymer having a Tg that is at least 15° C. lower than the Tg of the first layer.

8. The process of claim 1, wherein, in the separating step, the first layer is pulled by a first layer pull-roll and the remainder of the tapered multilayer interlayer sheet is pulled by a remainder pull roll, and
wherein a distance between the first layer pull-roll and the remainder pull-roll is maintained, that is less than about 50% of the width of the sheet, while the separating occurs.

9. The process of claim 1, further comprising cooling one or more of the first layer and the remainder of the tapered multilayer interlayer sheet below a Tg of a poly(vinyl butyral) of the first layer or a Tg of a poly(vinyl butyral) of the remainder of the tapered multilayer interlayer sheet.

10. The process of claim 1, further comprising cooling the first layer to a temperature from about 15° C. to about 30° C.

11. The process of claim 1, further comprising cooling the remainder of the tapered multilayer interlayer sheet to a temperature from about −15° C. to about 0° C.

12. The process of claim 1, wherein the distance between the first layer pull-roll and the remainder pull-roll is less than about 15% of the width of the sheet, while the separating occurs.

13. The process of claim 1, wherein the distance between the first layer pull-roll and the remainder pull-roll is less than about 5% of the width of the sheet, while the separating occurs.

14. The process of claim 1, wherein the tapered multilayer interlayer sheet comprises a core layer, with a skin layer on each side.

15. The process of claim 1, wherein the first layer comprises a first skin layer, and wherein the first skin layer is thicker than the other skin layer.

16. The process of claim 1, wherein the first layer comprises a first skin layer, and wherein the first skin layer is thinner than the other skin layer.

17. The process of claim 1, wherein the positioning roll is tilted at least 0.01 milliradians and less than 0.05 milliradians in the Z direction.

18. A continuous process for separating a first layer from a remainder of a tapered poly(vinyl acetal) multilayer interlayer sheet, the process comprising:
a. heating the tapered multilayer interlayer sheet to a temperature from about 25° C. to about 70° C.; and
b. thereafter separating the first layer from the remainder of the tapered multilayer interlayer sheet by pulling the first layer and the remainder of the tapered multilayer interlayer sheet in different directions,
wherein an angle α defined by the first layer and the tapered multilayer interlayer sheet at the separation point is smaller than or equal to an angle β defined by the tapered multilayer interlayer sheet and the remainder of the tapered multilayer interlayer sheet at the separation point, during the continuous process, and
wherein the tapered multilayer interlayer sheet has a thicker side and a thinner side, and wherein a heating unit located before the separation point is positioned so that it is tilted in the Z direction up to about 1% of the heating unit roll length, or in the Y direction up to about 0.5% of the heating unit roll length, or in both the Z direction up to about 1% of the heating unit roll length and in the Y direction up to about 0.5% of the heating unit roll length, to prevent the thicker side of the tapered poly(vinyl acetal) multilayer interlayer sheet from shifting toward the middle of the heating unit, during the continuous process.

19. The process of claim 18, wherein the first layer comprises a poly(vinyl butyral) polymer having a Tg from about 25° C. to about 40° C.

20. The process of claim 18, wherein the tapered multilayer interlayer sheet is heated in step a) to a temperature from 30° C. to 70° C.

21. The process of claim 18, wherein at least a portion of the remainder of the tapered multilayer interlayer sheet comprises a poly(vinyl butyral) polymer having a Tg that is at least 15° C. lower than the Tg of the first layer.

22. The process of claim 18, wherein the heating unit is tilted at least 0.01 milliradians and less than 0.05 milliradians in the Z direction.

23. An interlayer containing the first layer obtained in the process of claim 1.

24. A composition containing the first layer obtained in the process of claim 1.
